(19) United States
(12) Patent Application Publication
(10) Pub. No.: US 2017/0255229 A1
(43) Pub. Date: Sep. 7, 2017

(54) VIRTUAL REALITY VIEWER

(71) Applicant: DODOcase, Inc., San Francisco, CA (US)

(72) Inventor: Patrick Buckley, Mill Valley, CA (US)

(73) Assignee: DODOcase, Inc., San Francisco, CA (US)

(21) Appl. No.: 15/450,385

(22) Filed: Mar. 6, 2017

Related U.S. Application Data
(60) Provisional application No. 62/303,502, filed on Mar. 4, 2016.

(51) Int. Cl. G06F 1/16

(52) U.S. Cl. CPC G06F 1/163

(57) ABSTRACT

A virtual reality viewer is disclosed. The virtual reality viewer is easily switched between a first configuration and a second configuration. The first configuration allows a user to use the virtual reality viewer to view a virtual reality environment. The second configuration is smaller than the first configuration to improving storability, portability, and/or protect the viewer lenses when not in use.

### CROSS-REFERENCE TO RELAYED APPLICATIONS

The present application is related to and includes U.S. Provisional Patent Application Ser. No. 62/025,376 titled “SYSTEM AND METHOD FOR VR HEADSET USER INTERACTION” filed on Jul. 16, 2014; U.S. Provisional Patent Application Ser. No. 62/161,857, titled “SYSTEM AND METHOD FOR VIRTUAL REALITY HEADSET USER INTERACTION THROUGH ELECTROMECHANICAL DEVICE AND TOUCHSCREEN,” filed on May 14, 2015; U.S. Provisional Patent Application Ser. No. 62/260,326, titled “SYSTEM AND METHOD FOR VIRTUAL REALITY VIEWER,” filed on Nov. 26, 2015; U.S. Provisional Patent Application Ser. No. 62/303,502, titled “VIRTUAL REALITY VIEWER,” filed on Mar. 4, 2016; U.S. patent application Ser. No. 14/801,606, titled “VIRTUAL REALITY VIEWER AND INPUT MECHANISM,” filed on Jul. 16, 2015; U.S. patent application Ser. No. 15/209,397, titled “VIRTUAL REALITY VIEWER AND INPUT MECHANISM,” filed on Jul. 13, 2016; and U.S. patent application Ser. No. 15/362,817, titled “SYSTEM AND METHOD FOR VIRTUAL REALITY VIEWER,” filed on Nov. 29, 2016, which are each hereby incorporated by reference as if set forth in their respective entireties herein.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

The present invention relates to virtual reality viewer devices.

### BRIEF SUMMARY OF THE INVENTION

A virtual reality viewer is disclosed. A user can switch the virtual reality viewer between an operable configuration and a compact configuration. In the operable configuration, a user may use the viewer to view a virtual reality environment. In the compact configuration, the viewer may be more easily stored and moved about and may offer protection to certain viewer components.

In one embodiment, a virtual reality viewer comprises a face plate and a temple piece pivotably mounted to the face plate, wherein the temple piece extends away from a face of a user of the virtual reality viewer.

In another embodiment, a virtual reality viewer comprises a lens assembly having a lens, the lens having a first side and a second side, a first cover coupleable to a first portion of the lens assembly and having a first position that protects the first side of the lens, a second cover, pivotably coupled to a second portion of the lens assembly, the second cover having a first position that protects the second side of the lens.

In another embodiment, a virtual reality viewer comprises a first configuration in which a major dimension of a temple piece is generally parallel to a major dimension of a face plate, and a second configuration in which the major dimension of the temple piece is generally perpendicular to the major dimension of the face plate, wherein the virtual reality viewer may be reversibly switched between the first configuration and the second configuration.

In another embodiment, a method of using a virtual reality viewer is provided. The method includes unfolding, via a first pivot, a first temple piece from a face plate, unfolding, via a second pivot, a second temple piece from the face plate, placing an electronic device between the first temple piece and the second temple piece, removing the electronic device from between the first temple piece and the second temple piece, folding the first temple piece to the face plate, and folding the second temple piece to the face plate.

### BRIEF DESCRIPTION OF THE SEVERAL VIEWS OF THE DRAWINGS

FIG. 1 illustrates the front of an exemplary virtual reality viewer.

FIG. 2A illustrates the back of the exemplary virtual reality viewer shown in FIG. 1 in an unfolded configuration.

FIG. 2B illustrates the front of the exemplary virtual reality viewer shown in FIG. 1 in an unfolded configuration.

FIG. 2C illustrates the front of the exemplary virtual reality viewer shown in FIG. 1 in a folded configuration.

FIG. 2D illustrates the back of the exemplary virtual reality viewer shown in FIG. 1 in a folded configuration.

FIG. 3 illustrates a close up of an exemplary right temple piece of the exemplary virtual reality viewer shown in FIG. 1.

FIG. 4 illustrates the pieces of an exemplary cover for the exemplary virtual reality viewer shown in FIG. 1.

FIG. 5 illustrates the front and back portions of an exemplary face plate of the exemplary virtual reality viewer shown in FIG. 1.

FIG. 6 illustrates the top of an exemplary face plate of the exemplary virtual reality viewer shown in FIG. 1.

FIGS. 7A and 7B illustrate the installation of the exemplary cover.

FIG. 7C illustrates the exemplary cover positioned over the lenses of an exemplary virtual reality viewer.

FIG. 8 illustrates the exemplary virtual reality viewer of FIG. 1 in an unfolded configuration and having an exemplary electronic device installed.

FIG. 9 illustrates the exemplary configuration of FIG. 8 with the exemplary cover positioned over the top of the exemplary viewer.

The figures depict various example embodiments of the present disclosure for purposes of illustration only. One skilled in the art will readily recognize from the following discussion that other example embodiments based on alternative structures and methods may be implemented without departing from the principles of the disclosure.

### DETAILED DESCRIPTION OF THE INVENTION

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

According to an aspect of the subject application, the disclosed systems and methods provide a virtual reality viewer for use with a wide variety of personal electronic devices (e.g., a smartphone) as the visual display device, and having a configuration that is easily transitioned from an operative condition to a folded configuration.

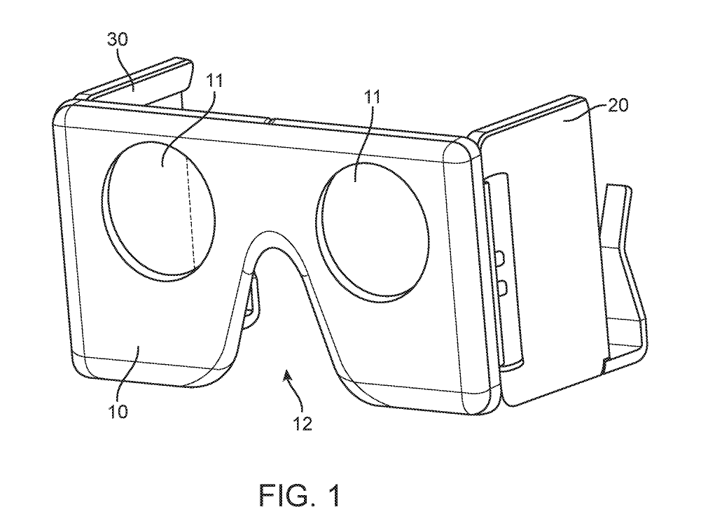

An example configuration of a virtual reality viewer in accordance with one or more embodiments of the invention is shown below and further described herein. FIG. 1 illustrates the front of an exemplary virtual reality viewer. Virtual reality viewer includes a face plate/lens frame/lens assembly 10 that includes lenses 11 and nose opening 12. Viewer further includes a right temple piece 20 and a left temple piece 30. As should be clear from the above description, “front” refers to the side of the viewer closest to the user's face when the viewer is in use, “back” or “rear” refers to the opposite side of the front, “bottom” refers to the side adjacent to the front side and nearest the nose opening 12, and “top” refers to the side opposite the bottom.

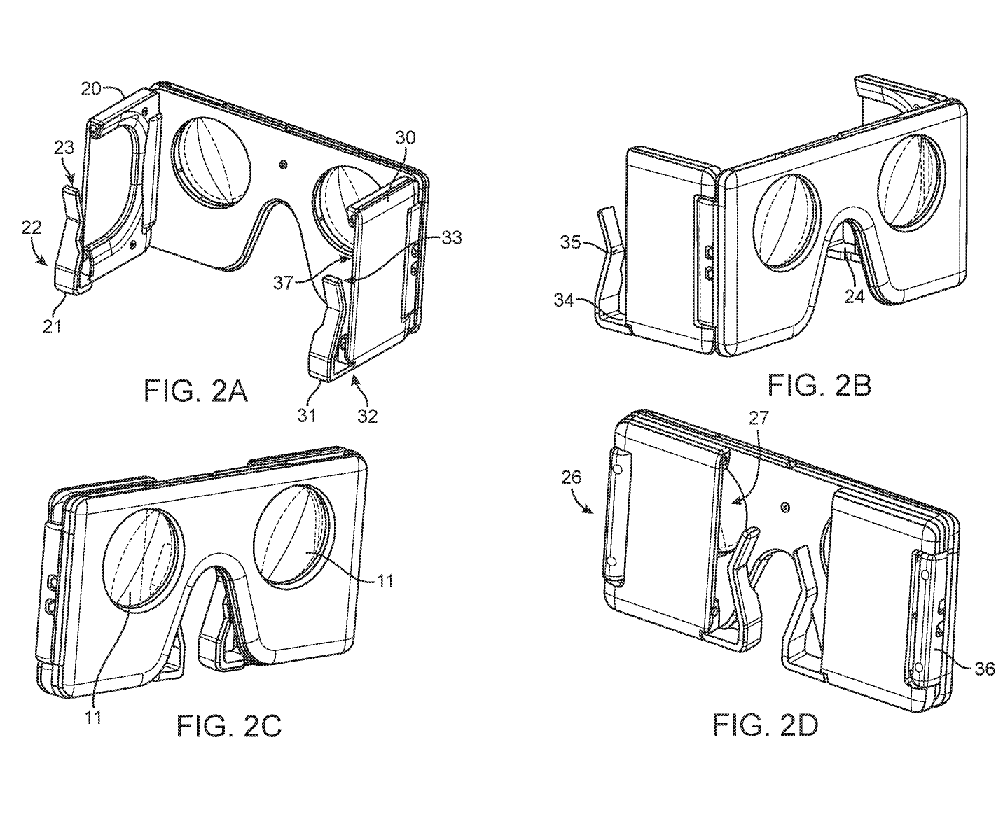

FIGS. 2A and 2B respectively illustrate the back and the front of the exemplary virtual reality viewer shown in FIG. 1 when in an unfolded configuration. As shown, each of the temple pieces 20, 30 includes a clip 21, 31 for holding a phone when inserted. Temple clips 21, 31 extend from the end of the temple wall to define open ends 22, 32 and accommodate phones with different lengths. The temple clips are flared out at the distal end 23, 33 to easily receive phones of varying widths when inserted. In addition, the bottom side of the clip 24, 34 that the phone rests on when inserted has a depth that can accommodate varying phone thicknesses. Between the bottom of the clip and the distal end, the clip extends or flares inward towards the temple wall. Accordingly, the gap between the clip and the wall of the temple piece decreases. Accordingly, this inward flare is provided to engage the phone and press it against pliable bumpers that are placed on the ends of the temple wall. In this example a small portion 35 of the length of the clip is engaging the phone accordingly inserting the phone doesn't require rubbing of the phone against a substantial portion of the clip. The clip is also preferably formed from a resilient and rigid material that is sufficiently flexible so that it can deflect when a phone is inserted and presses the phone against the bumpers/temple wall with sufficient force to hold the phone in place and without damaging the phone. In some embodiments, other mechanisms may be used to secure the phone or electronic device to the viewer (e.g., elastic straps secured to the face plate). As shown in FIGS. 2A and 2B, the major dimension of each temple piece is generally perpendicular to the major dimension of the face plate when the viewer is in the unfolded configuration.

FIGS. 2C and 2D respectively illustrate the front and back of the exemplary virtual reality viewer shown in FIG. 1 when in a folded configuration. To transition between the unfolded and folded configuration, the right temple piece 20 and left temple piece 30 are pivotably mounted to the face plate 10. In one embodiment, right temple piece 20 and left temple piece 30 are pivotably mounted to the face plate 10 via lugs 26, 36 that are installed on face plate 10. Screws or other fasteners (not shown) may extend through the top and bottom of temple pieces 20, 30 into the top and bottom of lugs 26, 36 and tightened so that temple pieces 20, 30 fold and unfold from face plate 10 in a smooth and consistent manner. As shown in FIGS. 2C and 2D, the major dimension of each temple piece is generally parallel to the major dimension of the face plate when the viewer is in the folded configuration.

As shown, hinges join the temple pieces 20, 30 and the face plate 10 to allow the temple pieces 20, 30 to be folded inward toward the face plate 10. It can be appreciated that other joining mechanisms can be used to provide a collapsible/folding viewer. The hinges are preferably tightened such that there is sufficient resistance when opening and folding the viewer. This keeps the temple pieces firmly in place when in either the operative or folded condition. The hinges can also include a lug or other such mechanism to attach a lanyard that can be worn around a user's neck (for example, a lanyard with integrated headphones). In some embodiments, the movement between a temple piece and the face plate may be resisted at one or more positions via an arresting mechanism (e.g., a ball detent).

As shown in FIG. 2C, lenses 11 may have a convex surface. In one embodiment, face plate 10 is of sufficient depth to avoid the convex surface of lenses 11 from extending beyond the front and back surfaces of face plate 10.

When the temple pieces 20, 30 are in the folded position, they cover and protect the convex side of the lenses that face towards the smartphone during use. In one embodiment, inner portions of right temple piece 20 and left temple piece 30 include a hollow/depression 27 (FIG. 2D), 37 (FIG. 2A) so that there is no rubbing between the convex side of the lens and the inner surface of the temple piece when the temple pieces are folded inward. Further, this depression permits the back surface of lenses 11 to extend beyond the back surface of face plate 10 while still allowing the temple pieces to fold flush with the face plate 10 when the viewer is in a folded configuration.

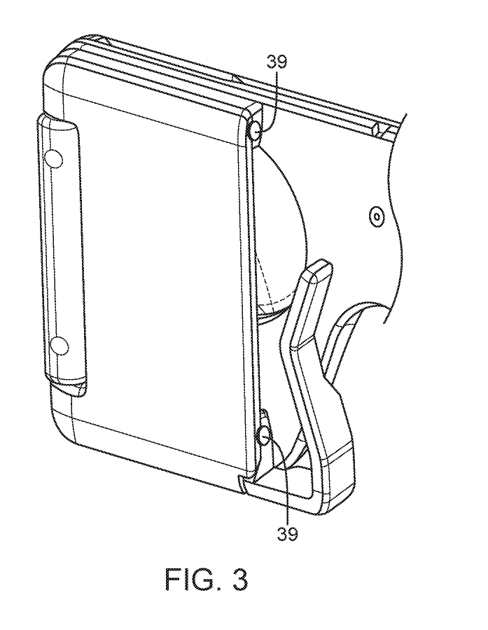

FIG. 3 illustrates a close up of a right temple piece of the exemplary virtual reality viewer shown in FIG. 1. In this embodiment, grip bumpers 39 are placed towards the top and bottom on the sidewall of both temple pieces 20, 30 to grip/hold the phone when inserted. The grip bumpers 39 also provide spacing between the phone's screen surface and the temple sidewall to prevent any buttons on the phones front face/screen surface from being depressed or actuated or damage to the screen. The grip bumpers 39 may be formed of an elastomer or other suitable material.

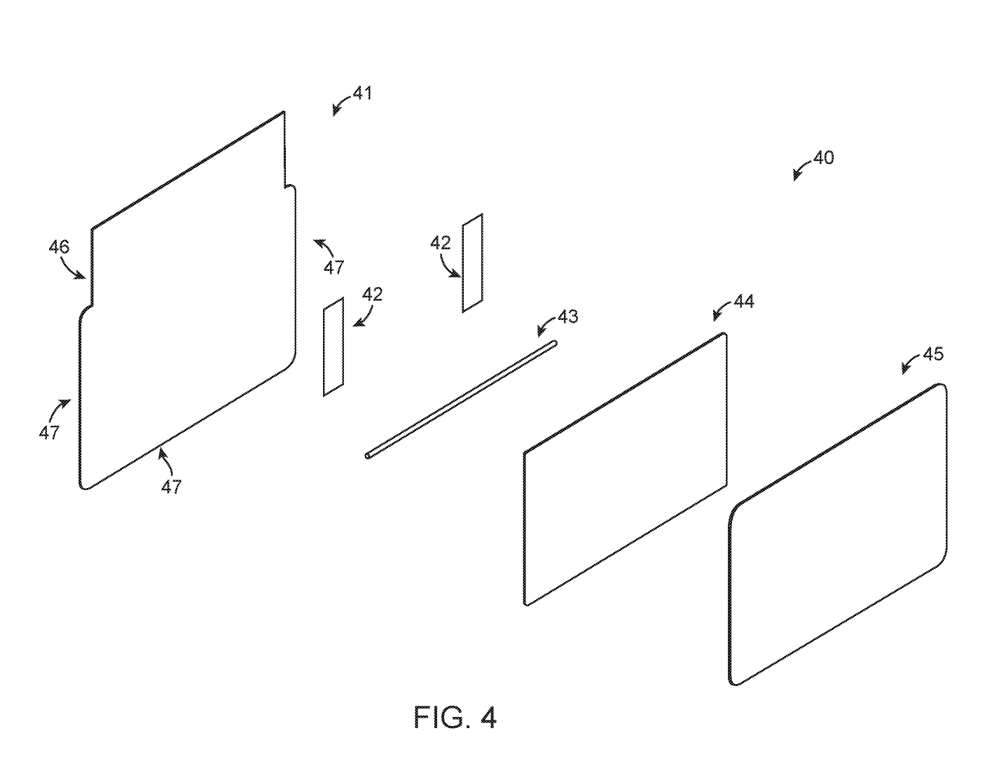

FIG. 4 illustrates the pieces of an exemplary cover 40 for the exemplary virtual reality viewer shown in FIG. 1. The cover preferably includes a rigid core 44 placed, e.g., a metal sheet, secured between an outer material layer 41 and an outer material layer 45. In this exemplary configuration, the edges of the material layers 41, 45 extend beyond the rigid core so they can be fused or otherwise joined so that the edges 47 of the cover are flexible. For example, the flexible edge can be between approximately 4 mm in width. In some embodiments, the height and width of the cover may be dimensioned to match the height and width of the face plate.

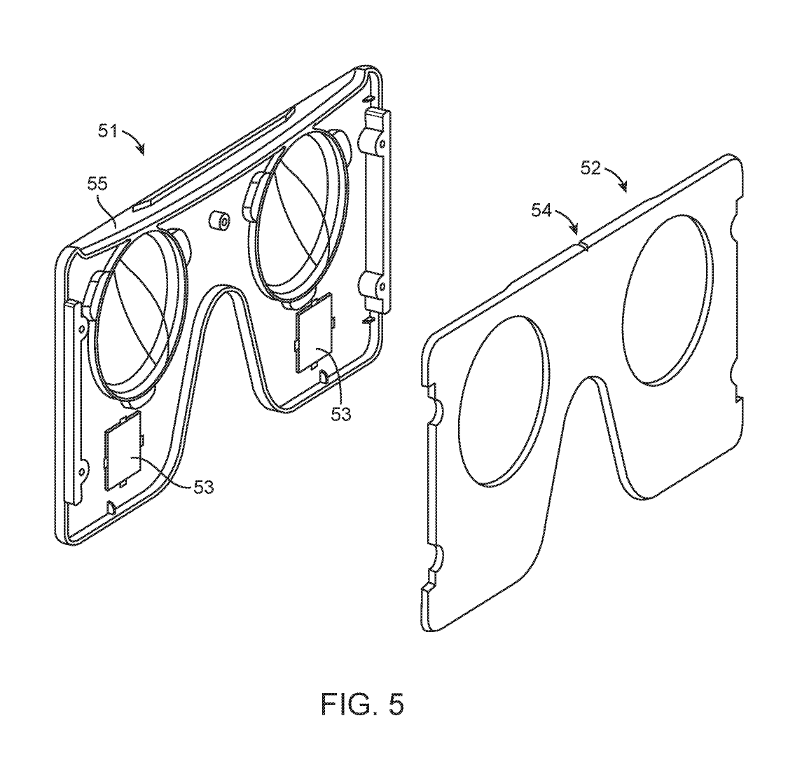

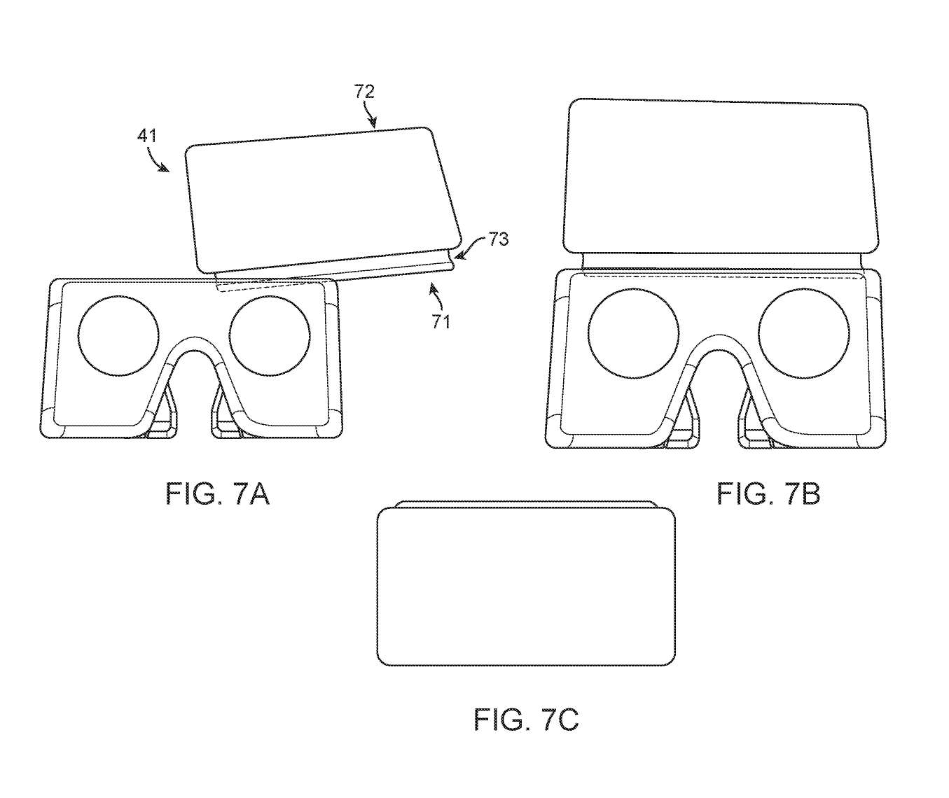

As shown, outer material layer 41 includes an extended portion 46 which may be used to secure a rod 43, e.g., a metal rod, with the use of an adhesive 42 by folding extended portion 46 over the metal rod 43. In this manner and with reference to FIG. 7, the cover includes an end 72 that holds the rigid core that attached to an end that holds the rod 71 by a flexible portion 73. As will be discussed below with reference to FIG. 5, the viewer includes a channel for installing the cover. When the rod end of the cover is in position in the channel, due to the flexibility of the portion of the cover 73 between the metal rod and the rigid core, the cover can be transitioned from an operative condition in which it defines the top side of the viewer to a collapsed condition, in which the cover provides a protective cover for the face plate 10 and the lenses 11 held therein. In addition, the material layer 41 can be a soft material (e.g., microsuede). Accordingly, the soft material protects the outer surface of the lenses when the cover is in the closed position. In addition, the soft and flexible edges of the cover can be used to clean the lenses of the viewer. The material layer 45 is preferably formed of a durable material such as polyurethane or leather that can be embellished, e.g., printed, embossed, etc., with, e.g., a logo.

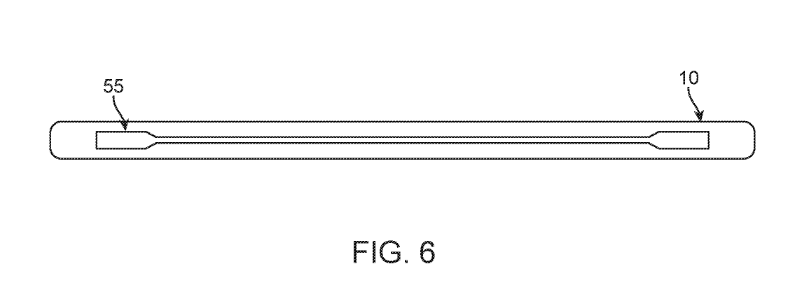

FIG. 5 illustrates the front 51 and back 52 portions of a face plate 10 of the exemplary virtual reality viewer shown in FIG. 1. When assembled, the front 51 and back 52 portions of face plate form a channel 55 having an opening at the top end that runs the length of the channel (FIG. 6). The channel can be c-shaped such that the rod portion of the cover can be slid into the channel and held in place once it is inserted. As shown in FIG. 6, the gap in the channel 55 can be wider towards the edges and narrower in the center to facilitate insertion of the cover (described below with reference to FIGS. 7A-7C).

As shown in FIG. 5, the face plate 10 can also be defined to include a notch 54 or other sighting feature in the middle of the face plate (e.g., in the center of the top edge of the face plate, or the bottom section at the apex of the nose area) allowing the user to align the middle of the viewer with the center of the devices screen when inserting the device.

As shown in FIG. 5, one or more magnets 53 may be provided on or within the face plate so that the cover (which has the metal sheet therein) is held firmly against the face-plate by the magnets when in the folded position. The metal layer also provides rigidity to the cover, allowing it to provide a rigid top of the viewer when in use, and a protective cover for the lenses when in the folded position.

FIGS. 7A and 7B illustrate the installation of the exemplary cover. In this example, the end of the cover having the rod therein 71 is configured to be inserted into one or more larger openings in the channel 55 that are located towards the ends of the channel. The rod 43 can have a flexibility that allows it to be inserted into the opening and slid into position and, when released, provides a clipping action as it returns to its un-flexed state and securely engages the walls of the channel 55 (see FIG. 7B). As noted above, the channel 55 is defined such that it narrows towards the middle section, to engage the rod when inserted and keeps it in place. Accordingly, less interference occurs towards the ends where gaps are wider. In this exemplary configuration, the groove has a width and the face plate material defining the channel has a sufficient flexibility such that, when the cover portion is pulled directly away from the face plate with sufficient force, the material holding the rod in place deflects and allows the 41 cover to be disengaged from the face plate 10. It is understood that the face plate material is preferably rigid enough to hold the rod securely in place. Moreover, this exemplary configuration of the channel, which has a narrower gap in the middle and wider gaps towards the ends, allows the user to disengage the cover from the groove by pulling the cover away from the channel at the wider gap sections. The flexible portion of cover 73 allows the cover to fold over the front of the face plate 10. The cover serves to protect lenses when in folded condition. When the viewer is unfolded, cover 41 may be folded in the opposite direction to block exterior light. Preferably, the cover 41 is easily removable so it is customizable or can be swapped.

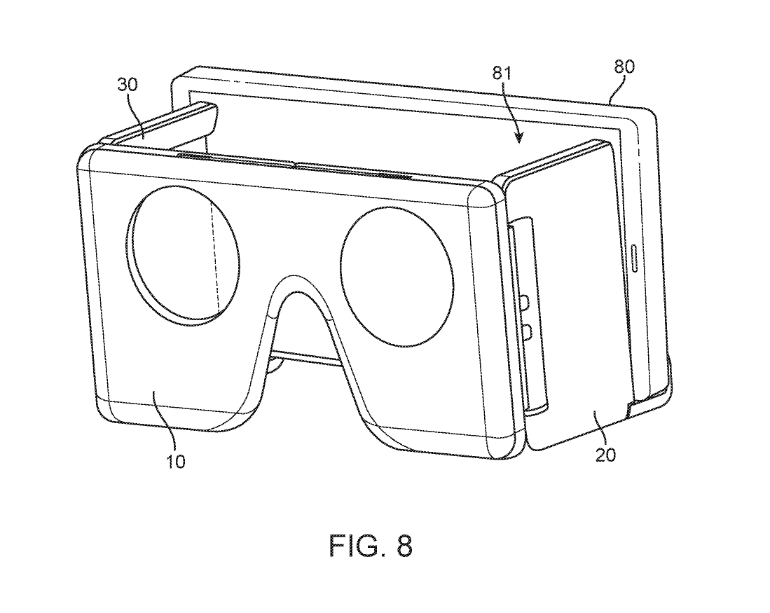

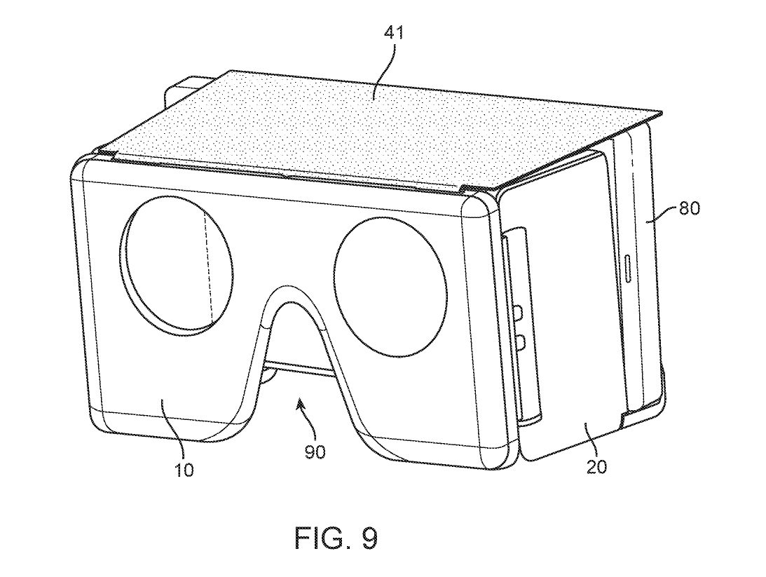

FIG. 8 illustrates the exemplary virtual reality viewer of FIG. 1 in an unfolded configuration and having an exemplary electronic device 80 installed in clips 21, 31 (not shown). It can be seen that open ends 22, 32 and openings at distal ends 23, 33 permit the viewer to receive electronic devices 80 having varying sizes. FIG. 9 illustrates the exemplary configuration of FIG. 8 with the exemplary cover 41 installed and positioned over the top of the exemplary viewer. In some embodiments, the cover may rest on the top of temple pieces 20, 30 in an orientation generally perpendicular to both the face plate 10 and the temple pieces 20, 30. As shown in FIG. 9, the size of the electronic device 80 may result in the cover 41 resting on top of an edge of the electronic device 80.

It can be appreciated that the cover and the temple pieces provide a light blocking feature when the viewer is used so as to darken the interior of the viewer. However, as shown the bottom of the viewer is left open such that the user can access the touch-screen of the device when in use.

The hinges and the top wall, which has flexible edges allowing it to be folded from the operational state to the collapsed state covering the lenses, allow the viewer device to fold flat when not in use. Thus it is easily stored and the lenses are protected. Moreover, the folding temples allows the viewer to be quickly and easily transitioned between a compact condition and an operative condition. The same applies to the folding cover. The transition is reversible as it does not require any special tools (e.g., a screwdriver), materials (e.g., tape, glue, or other adhesive), or disassembly to change between the compact configuration and the operative configuration. Further, the resulting size of the folded configuration may be comparable to a smartphone, thus improving the viewer's portability and allowing a user to easily carry the viewer. That is, the folded viewer has a first and a second dimension that generally match the size of screen of a compatible electronic device, and a third dimension that is smaller than the other two.

One or more pieces of the viewer (e.g., face plate, temple pieces) can be fabricated, for example, by injection molding using a plastic material, such as, nylon, polyurethane, an ABS material, polycarbonate, an acrylic material, or similar materials. Obviously, other modern manufacturing techniques can be used to form the viewer described herein. It will also be understood that one or more components of the viewer can be formed of two or more constituent parts that are complementary to one another and can be joined to one another to form an assembled structure. For example, individual components can be joined together by heat welding, glue or other adhesive, rivets, screws, fasteners, slot and tab joints or other suitable temporary or permanent joining means.

The various components of the viewer can be composed of other conventional materials that are suitable including but not limited to plastic, one or more sheet metal stampings, or other natural or synthetic materials.

It is to be understood that like numerals in the drawings represent like elements through the several figures, and that not all components and/or steps described and illustrated with reference to the figures are required for all embodiments or arrangements.

The subject matter described above is provided by way of illustration only and should not be construed as limiting. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, as set forth in each and any of the following claims.

1. A virtual reality viewer comprising:
a face plate; and
a temple piece pivotably mounted to a first portion of the face plate,
wherein the temple piece extends away from a face of a user of the virtual reality viewer.

2. The virtual reality viewer of claim 1, wherein the temple piece is configured to hold a portable electronic device.

3. The virtual reality viewer of claim 2, wherein the temple piece includes one or more bumpers to secure the portable electronic device.

4. The virtual reality viewer of claim 1, further comprising a cover coupleable to a second portion of the face plate, wherein the cover has generally the same width and height as the face plate.

5. The virtual reality viewer of claim 4, wherein the face plate comprises a magnet and wherein the cover includes a magnetic material such that the cover is magnetically attracted to the magnet when the cover is folded flush with the face plate.

6. The virtual reality viewer of claim 4, wherein the cover is flexibly and removably coupled to the second portion of the face plate and foldable flush with the face plate.

7. The virtual reality viewer of claim 2, further comprising a portable electronic device having a display, wherein the display is oriented to face the face plate when held by the temple piece.

8. A virtual reality viewer comprising:
a lens assembly having a lens, the lens having a first side and a second side;
a first cover coupleable to a first portion of the lens assembly and having a first position that protects the first side of the lens;
a second cover, pivotably coupled to a second portion of the lens assembly, the second cover having a first position that protects the second side of the lens.

9. The virtual reality viewer of claim 8, wherein the second cover comprises a temple piece, the temple piece configured to hold a portable electronic device.

10. The virtual reality viewer of claim 9, wherein the temple piece includes one or more bumpers to secure the portable electronic device.

11. The virtual reality viewer of claim 8, wherein the first cover has generally the same width and height as the lens assembly.

12. The virtual reality viewer of claim 4, wherein the lens assembly comprises a magnet and wherein the first cover includes a magnetic material such that the first cover is magnetically attracted to the magnet when the first cover is folded flush with the lens assembly.

13. The virtual reality viewer of claim 8, wherein the first cover is removably and flexibly coupleable to the first portion of the lens assembly.

14. The virtual reality viewer of claim 9, further comprising a portable electronic device having a display, wherein the display is oriented to face the lens assembly when held by the temple piece.

15. A virtual reality viewer comprising:
a first configuration in which a major dimension of a temple piece is generally parallel to a major dimension of a face plate; and
a second configuration in which the major dimension of the temple piece is generally perpendicular to the major dimension of the face plate, wherein the virtual reality viewer may be reversibly switched between the first configuration and the second configuration.

16. The virtual reality viewer of claim 15, wherein switching between the first configuration and the second configuration does not require a tool.

17. The virtual reality viewer of claim 15, wherein switching between the first configuration and the second configuration does not require additional materials.

18. The virtual reality viewer of claim 15, further comprising a cover that is generally flush with the face plate when the virtual reality viewer is in the first configuration and is generally perpendicular to the face plate and the temple piece when the virtual reality viewer is in the second configuration.

19. The virtual reality viewer of claim 18, wherein the cover has generally the same width and height as the face plate.
